(19) United States
(12) Patent Application Publication
(10) Pub. No.: US 2002/0033748 A1
(43) Pub. Date: Mar. 21, 2002

(54) TRANSFORMER

(76) Inventors: JOURI BOLOTINSKY, NETANYA (IL); EVGENI SORKIN, RAMAT AVIV (IL); ALEXANDER RUBENSTEIN, ASKALON (IL); ELIEZER ADAR, SDE VARBURG (IL); VLADIMIR MANOV, HAIFA (IL); VADIM SADCHIKOV, MOSCOW (RU); ALEXANDER FILIPPOV, MOSCOW (RU)

Correspondence Address: MORRISON & FOERSTER LLP, 2000 PENNSYLVANIA AVE, NW, SUITE 5500, WASHINGTON, DC, 20006-1888, US

(21) Appl. No.: 08/936,199

(22) Filed: Sep. 23, 1997

(51) Int. Cl. H01F 27/28; H01F 27/24

(52) U.S. Cl. 336/182; 336/229; 29/606; 29/602.1

(57) ABSTRACT

An electrical single-phase transformer with a coil and core(s) assembly having a polygon-shaped coil with two or more windings and a central window and a system of magnetic cores which extend through the coil window.

### FIELD OF THE INVENTION

The present invention relates to electrical transformers. More specifically, the present invention relates to electrical single-phase transformers of the type which include a coil and core(s) assembly having a polygon-shaped coil consisting of two or more windings with a central window and a system of magnetic cores which extend through the coil window.

### BACKGROUND OF THE INVENTION

Several approaches are known in the art of single-phase electrical transformer design. Different types of transformer core and coil assemblies are used at present. For example, transformers having so-called E+I type cores and C- type cores are known. Such cores are usually made from magnetic steel strips or sheets. The cross-sectional shape of the core is usually rectangular. This reduces the rate of filling in a coil window area. Such a coil window usually has a circular form. The E-core or C-core sheets are typically made by stamping. This tends to be a time-consuming operation, and is generally accompanied by large amounts of steel sheet waste. See, for example, the description provided in Kostenko M. P., Piotrovsky L. M., “Electrical Machines”, Moscow, 1964, p.357, p.532 (hereinafter “Kostenko et al.”).

Recently, electrical steel strips having a thickness of between about 0.1 mm and 0.15 mm have been produced. This allows the possibility of winding toroidal cores (as shown, for example, in FIG. 1). Such a toroid may be made from an electrical steel strip having a transverse section which defines, for example, a circular or a rectangular form. This method tends to reduce several problems in manufacturing of the core. However, this method also tends to make the process of winding transformer coils more complicated.

Such transformer types usually are used in low-current engineering. In this case, the transformer usually includes a coil with a high number of light wire turns (typically having a diameter of between about 0.05 mm and 1.5 mm). The coil is produced with special equipment. However, the winding of a transformer coil for a high power distribution transformer tends to be very complicated.

Transformers are known in which the cores are made from magnetic strip material, as described, for example, in Kostenko et al., and as shown, for example, in FIG. 2 herein. The coil of such a transformer is made in an overall rectangular form having a central rectangular window, with primary and secondary windings being stacked or coaxial and separated by insulation, so that the coil has a circular transverse section, as shown in FIG. 2. There are two strip-wound cores in the form of rolls which extend through the window in the coil and are placed on the opposite sides of the coil rectangle.

A method of making a distribution transformer is disclosed, for example, in U.S. Pat. No. 5,387,894 (incorporated herein by reference) and in U.S. Pat. No. 5,455,553 (incorporated herein by reference). The disclosed transformer has a wound magnetic core having an overall circular shape with a central window and two or four overall rectangular shaped electric coils extending through the core window. The magnetic core is made from a non-amorphous steel strip or from an annealed amorphous steel strip by winding the strip on a special mandrel.

In U.S. Pat. No. 5,387,894 and U.S. Pat. No. 5,455,553 each part of the coil on which the magnetic cores are assembled forms a circular cylinder. A special hollow circular cylindrical mandrel is placed around the circular cylinder. The mandrel is rotated to wind thereon a continuous, non-amorphous steel strip. A non-annealed, uncut magnetic core is thereby formed having a length which ranges between about 250 mm and about 1 m, having an overall circular shape and a rectangular cross section.

This construction allows a savings of between about 15% to 20% of the magnetic materials. A disadvantage of such design is that it requires a relatively more complex production technology in which a steel strip must be wound around a previously formed multi-turn coil. Another disadvantage arises from the fact that only the parts of the windings which are inside the cores are involved in the electromagnetic interaction process. The rest of the windings essentially serve as structural elements only. This results in significant core losses, increased transformer weight, and high production costs.

According to U.S. Pat. No. 5,387,894 and U.S. Pat. No. 5,455,553 it is possible to make the magnetic core from amorphous alloy ribbon by this method. In such case the as-cast amorphous ribbon is first wound on another mandrel and then annealed. The annealed ribbon is then transferred from this mandrel to a mandrel placed around the cylindrical part of the coil, thus forming an uncut core.

It is known that to obtain high magnetic properties, the as-cast amorphous ribbon must be annealed at an optimum annealing temperature which ranges from about 350° C. to about 550° C. for various compositions of magnetic amorphous ribbon. It is known that the amorphous ribbons become extremely brittle after annealing, and break under mechanical stress or during winding. This makes it virtually impossible to transfer an annealed ribbon from one mandrel to another, as proposed in these patents.

Consequently, in a preferred method the amorphous ribbon used is either non-annealed or annealed at a lower temperature. That is, T_{annealing}<250° C.-300° C. As a result, the magnetic properties of the ribbon annealed at a temperature of between about 250° C. and about 300° C. are lower than those of a ribbon annealed at an optimum temperature. An example for ribbon made of Fe_{90.5}B₃Ni_{1.5}Si₅ is given in Table 1 below:

TABLE 1

| | Non-annealed | | |
|---|---|---|---|
| Characteristics | ribbon | T = 200° C. | T = 350° C. |
| Bs (80 A/m) | 0.83 T | 0.85 T | 1.4 T |
| Losses (0.2 T) | 0.05 | 0.04 | 0.011 |
| Permeability (max) | 18000 | 18000 | 35000 |
| Hc (A/m) | 18.6 | 17 | 9.6 |

Consequently, in practice, the preferred method can not be used for making a magnetic core from amorphous materials, because annealing at an optimum temperature of between about 350° C. and about 550° C. fails to provide the core with high magnetic properties.

An object of the present invention is to provide an improved single-phase transformer for alternating current, which features higher efficiency, smaller core losses and lower expenditure of materials per unit power, and which is essentially free from the above-mentioned limitations and disadvantages.

### SUMMARY OF THE INVENTION

In accordance with the present invention, these and other objectives are achieved by providing a single-phase electrical transformer which includes a coil and at least one core assembly having a substantially polygonal-shaped coil consisting of two or more windings with a central window and a system of magnetic cores which extend through the coil window. These cores preferably have a toroidal form, and they are preferably made from amorphous or nanocrystalline ribbon.

In a preferred embodiment the primary and secondary transformer coil windings are insulated from one another and together form a polygonal-shaped coil (for example, a hexagon-shaped coil), with a central window and preferably a circular transverse section. The wires of the windings are preferably arranged essentially parallel to the side of the polygon. In some embodiments the transformer coil may also be produced in the form of a toroid, with a transverse section having a rectangular or other form. The magnetic toroidal cores of a transformer in accordance with the present invention may be placed along the transformer coil, with each core extending through the central window of the coil.

Each toroidal core may be produced initially with a rectangular cross-section in its axial plane. This is relatively easy to achieve when the core is wound from a strip. The portions of the cores which are placed inside the central window of the transformer coil may then be cut to provide “slants”. These slants essentially lie in planes which pass through the transformer symmetry axis, as shown for example in FIG. 3. This allows enlargement of the effective core section area, thereby increasing the total core section area in a plane which is essentially perpendicular to the transformer coil axis.

In a preferred embodiment the slants on the cores may be made with angle α, where α=360/(2n), and the slant length Lₛ=h/(cos α), where n is equal to the number of sides of the polygonal coil and h is equal to the core thickness. That is, h is equal to half of the difference between the inner diameter of the core and the outer diameter of the core, h=(D₁₆−D₁₄)/2.

In an embodiment in which the transformer has specific long cores (Lₛ>D₁₆), the slant may be cut over all the core so that the slant length Lₛ may be expressed by the formula Lₛ=D₁₆/cos α.

In a preferred embodiment each core consists of at least two separate parts, with the plane of their connection being perpendicular to the transformer central axis.

### BRIEF DESCRIPTION OF THE DRAWINGS

A detailed description of the preferred embodiments of the present invention will be made with reference to the accompanying drawings.

FIG. 1 shows an example of the structure of a conventional transformer which consists of two distributed windings and a toroidal core.

FIG. 2 shows an example of the structure of a transformer which consists of two strip-wound cores and a rectangular ring-shaped coil consisting of two windings which extend through the core windows.

FIG. 3 shows an example of a transformer according to one embodiment of the present invention, having a polygon-shaped coil with a circular cross section.

FIG. 4 shows an example of the transformer cross-section in the plane designated A-A in FIG. 3.

FIG. 5 shows, in an axonometrical view, an example of a transformer in accordance with the same embodiment of the present invention as shown in FIG. 3.

FIG. 6 shows an example of a transformer in accordance with the same embodiment of the present invention as shown in FIG. 3 in which the elements have been moved apart along the vertical axis.

FIG. 7 shows, in an axonometrical view, an example of a transformer in accordance with the present invention having a polygon-shaped coil with a rectangular cross section.

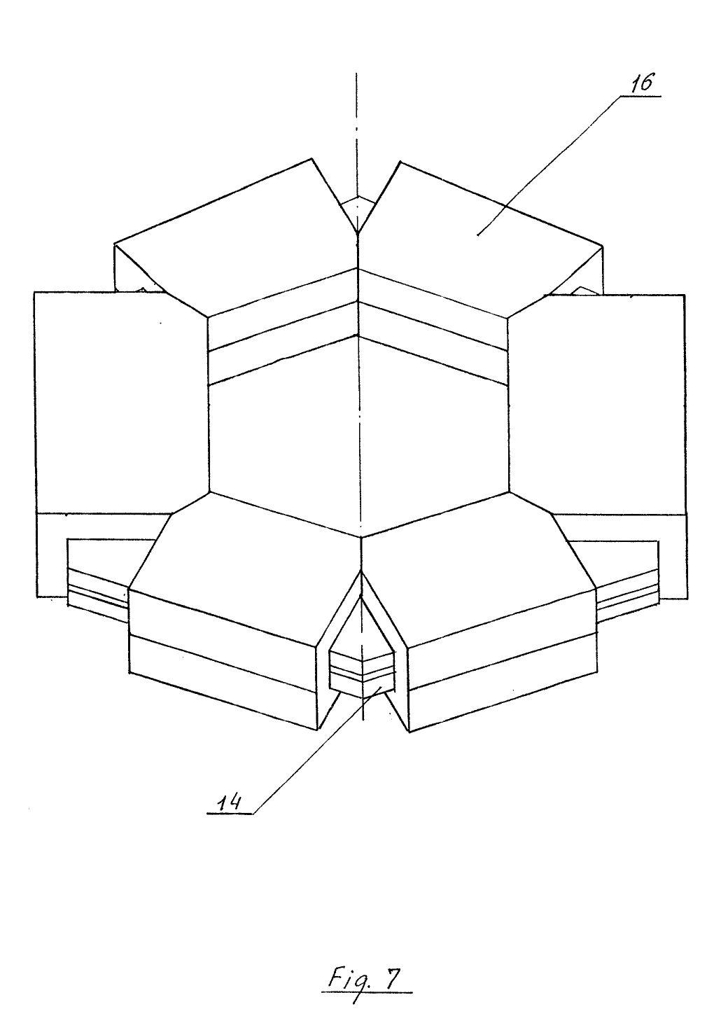

FIG. 8 shows an example of a transformer in accordance with the same embodiment of the present invention as shown in FIG. 7 in which the elements have been moved apart along the vertical axis.

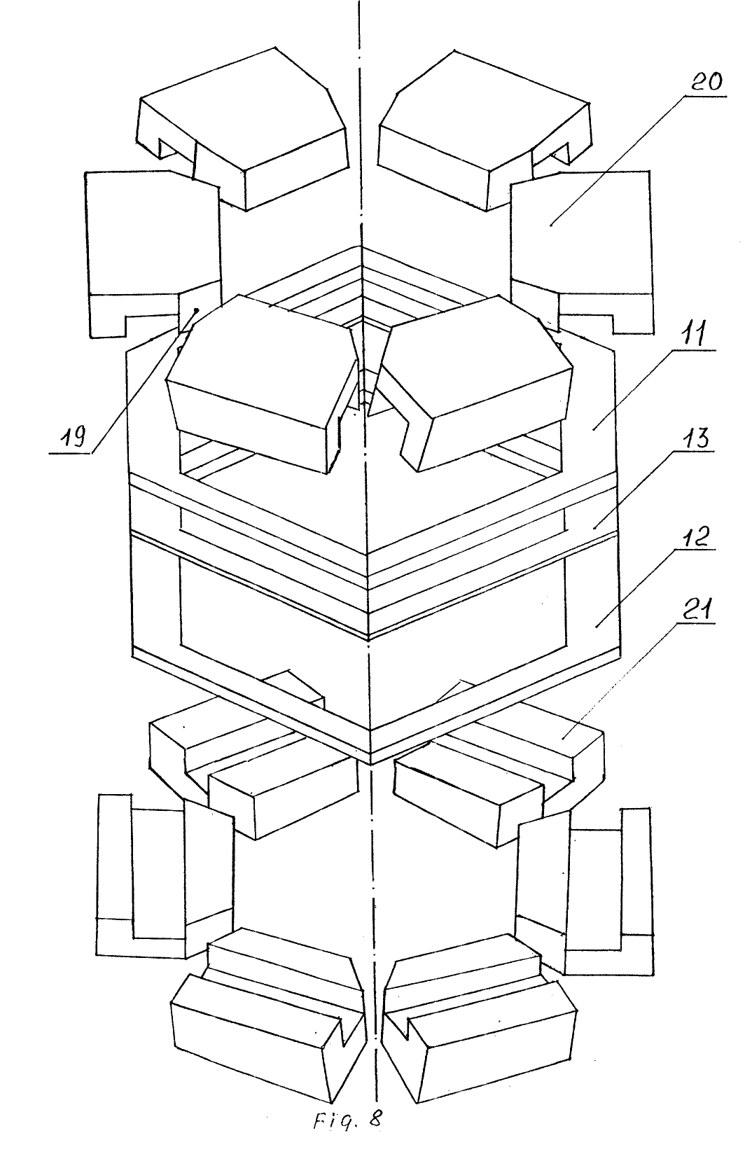

FIG. 9 shows, in an axonometrical view, an example of a transformer in accordance with the present invention having a toroidal coil with a circular cross section.

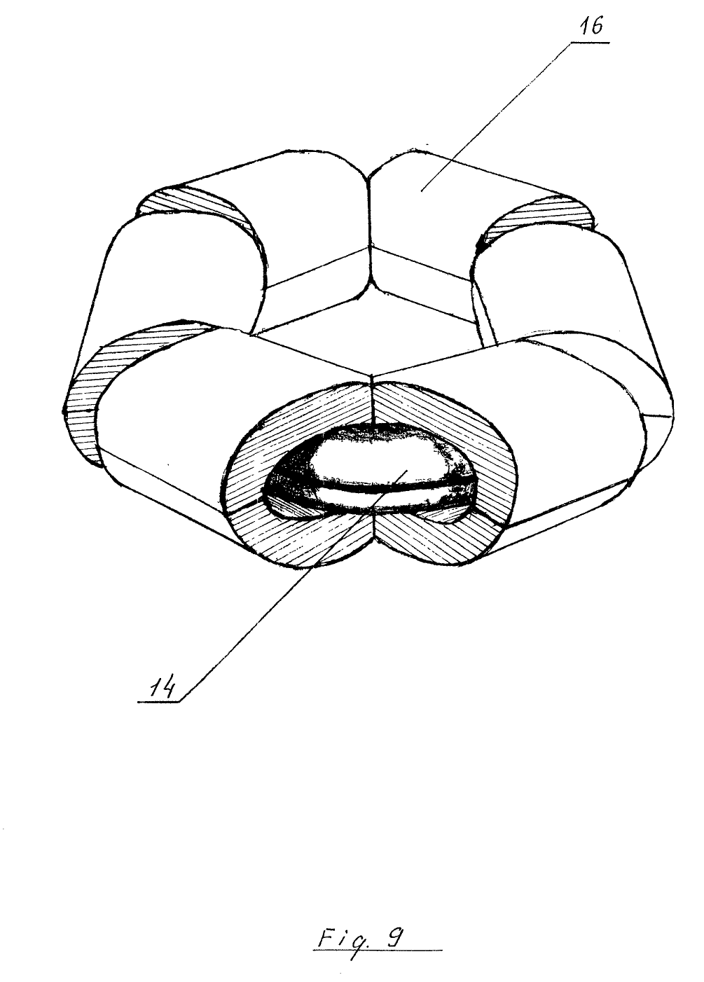

FIG. 10 shows an example of a transformer in accordance with the same embodiment of the present invention as shown in FIG. 9 in which the elements have been moved apart along the vertical axis.

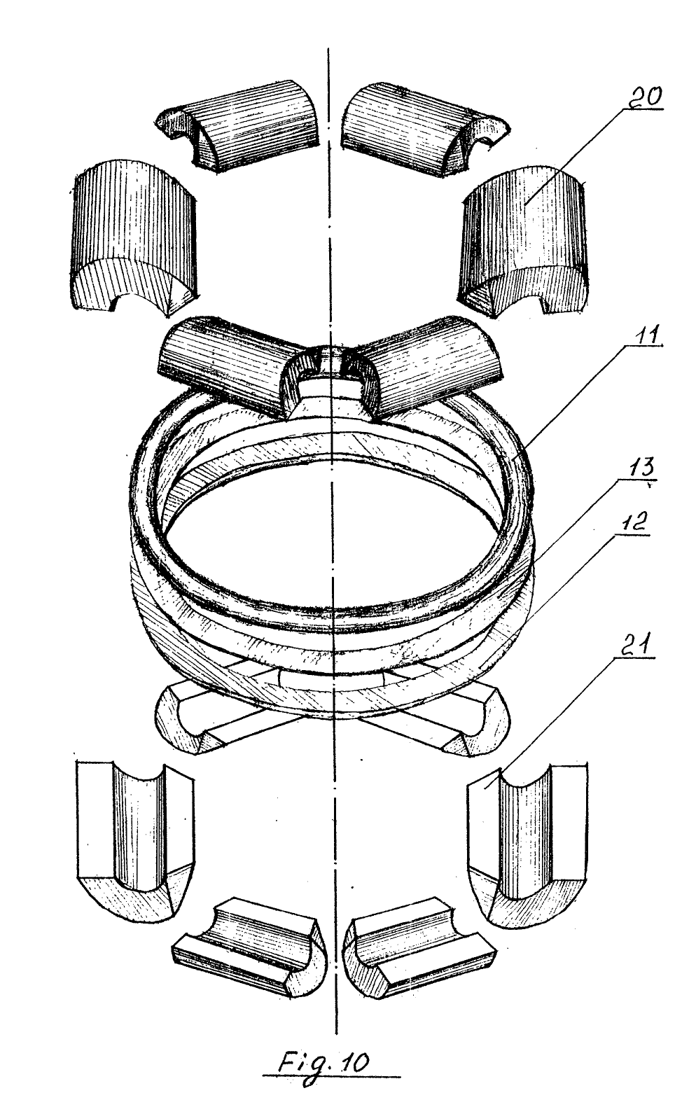

FIG. 11 shows, in an axonometrical view, an example of the transformer in accordance with the present invention having a toroidal coil with a rectangular cross section.

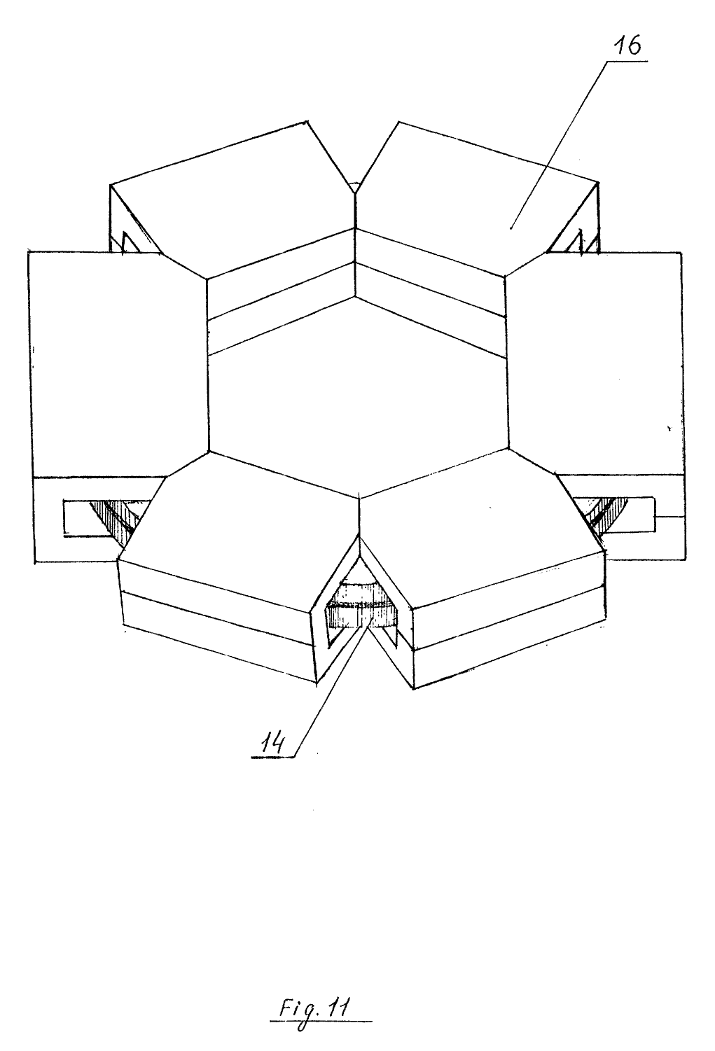

FIG. 12 shows an example of a transformer in accordance with the same embodiment of the present invention as shown in FIG. 11 in which the elements have been moved apart along the vertical axis.

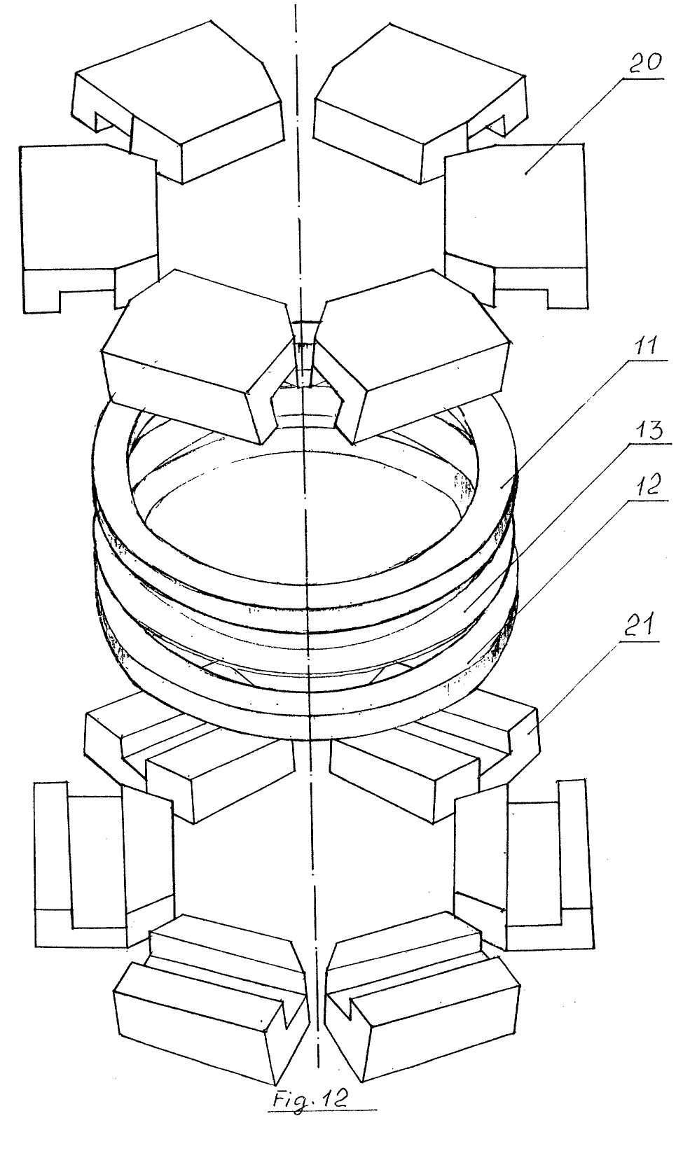

### DETAILED DESCRIPTION OF THE PREFERRED EMBODIMENTS

The following detailed description is of the best presently contemplated mode of carrying out the invention. This description is not to be taken in a limiting sense, but is made merely for the purpose of illustrating the general principles of the invention. The scope of the invention is defined by the appended claims.

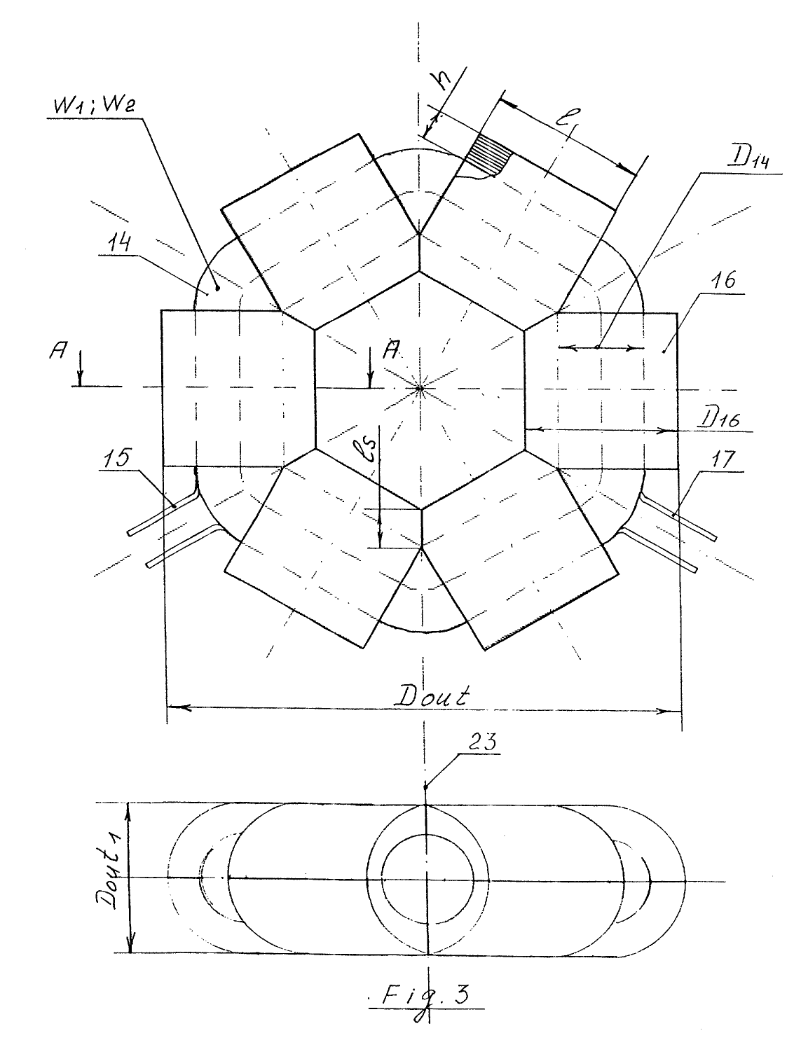

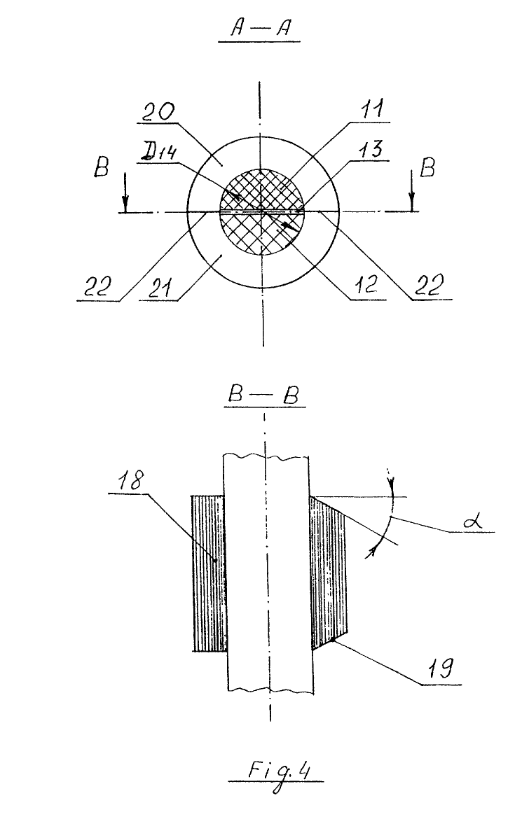

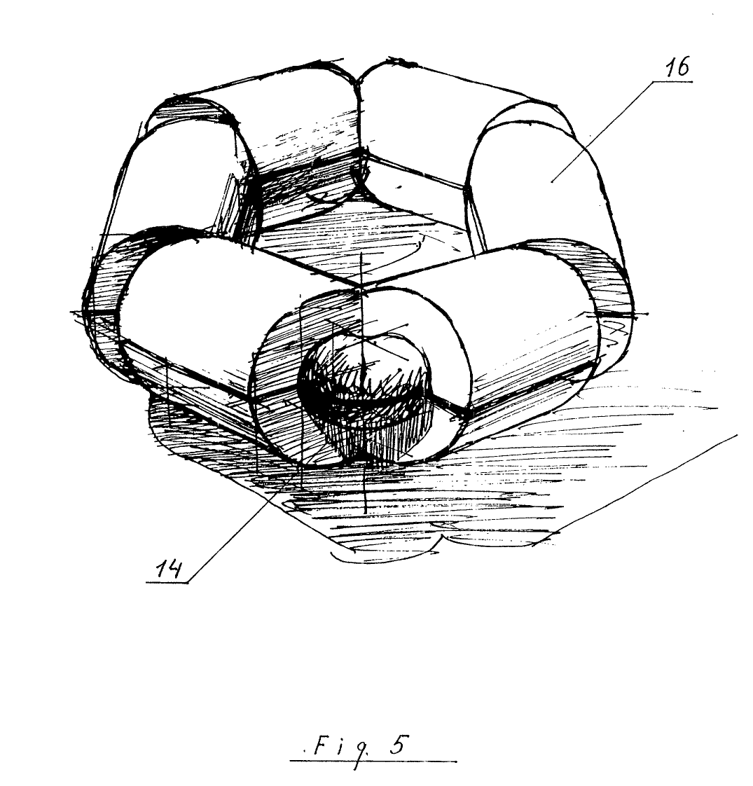

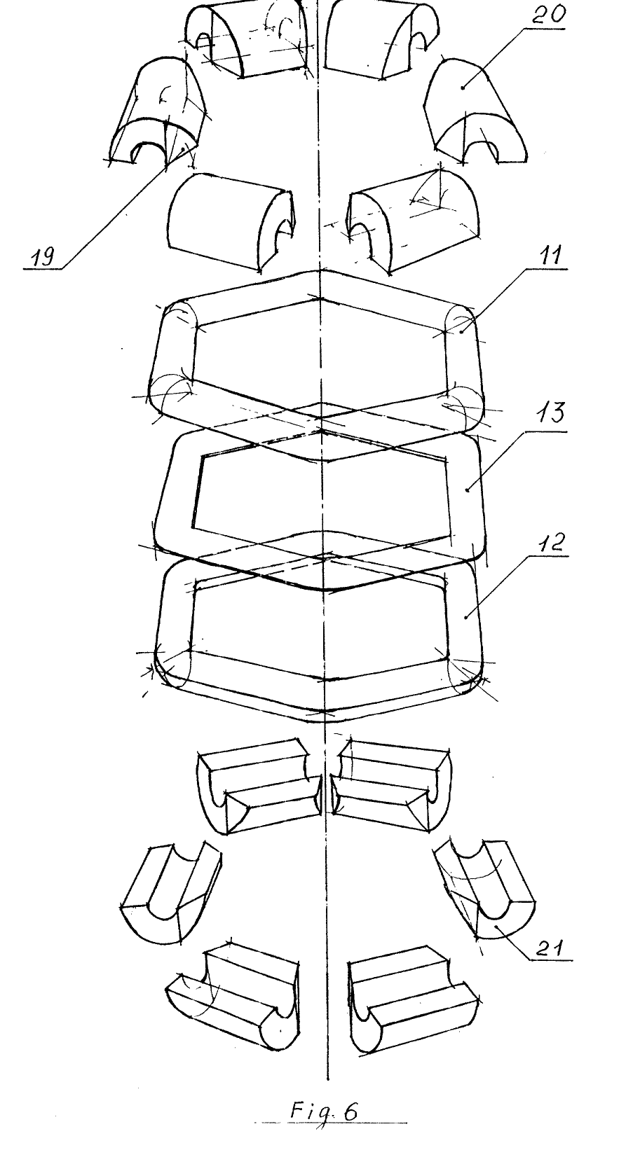

FIGS. 3, 4, 5 and 6 illustrate an example of a transformer in accordance with a preferred embodiment of the present invention. In this embodiment the transformer includes one or more primary windings 11 and one or more secondary windings 12. The primary windings 11 and the secondary windings 12 are insulated from one another. The primary windings 11 and the secondary windings 12 together form a coil 14. The coil 14 is preferably in the form of a polygonal ring having n sides. In the illustrated embodiment n is equal to six. When the terminals 15 at the ends of the primary windings 11 are connected to an alternating current source (not shown), the primary winding current creates an alternating magnetic flow which is concentrated by a plurality of the toroidal cores 16 and induces a secondary voltaged on the terminals 17 at the ends of the secondary winding 12.

In the illustrated embodiment the coil 14 has a circular cross section in a plane which passes through the axis of symmetry of the coil. The circular cross section of the coil 14 has an external diameter D₁₄. The toroidal cores 16 are placed along the perimeter of the coil 14. The cores 16 have an internal diameter that is essentially equal to the external diameter D₁₄ of the transverse section of the coil 14. The cores 16 are preferably made from amorphous or nanocrystalline ribbon 18.

For transformers which are made from conventional materials, it is known that maximum efficiency may be achieved by providing equal levels of core losses and winding losses. However, it has been discovered that if amorphous or nanocrystalline alloy strips are used as the core material, as in preferred embodiments of the present invention, then the core losses may be reduced to about two percent of their usual level. So, for example, losses for cold-rolled steel St 2411, which is usually used for a transformer at the frequency 50 Hz, would be P_{1.5/50}=3.0 W/kG at B=1.5 T. See, Mishin D. D. “Magnetic materials”, Moscow, 1991, p. 337. Losses for amorphous material, for example, amorphous metallic core Fe₈₁B₁₃Si₄C₂ at B=1.3 T and f=50 Hz, would be 0.06 W/kG.

Thus, the transformer efficiency depends essentially on the losses in the windings. This allows a high degree of efficiency (close to one) to be achieved for the idling mode of transformer operation. In such a case, the main criterion for the selection of transformer parameters is not the equivalence of core losses and winding losses, but is instead the provision of maximum induction in the core. When the maximum possible level of induction is chosen, it is possible to define the optimum parameters of the transformer with high efficiency.

The maximum induction in the core may be achieved by maximizing the volume of the copper winding wires involved into the interaction with the magnetic flow. This may be achieved by maximizing the amount of the windings which are embraced by the core 16. It is for that reason that the coil 14 is preferably made in the form of a polygonal ring, and the toroidal cores 16 which are placed along the transformer coil perimeter embrace nearly all the volume of the windings.

In a plane which is perpendicular to the transformer axis, each toroidal core 16 in the preferred embodiment has a substantially rectangular cross-section. Those portions of the toroidal cores 16 which extend through the central window of the coil 14 are produced with “slants” cut into their edges. This allows an increase in the total core section in a plane which is perpendicular to the transformer axis.

The number of toroidal cores, n, is chosen according to the electrical calculations with a view to providing the maximum total section of the core in the plane perpendicular to the transformer axis.

The slants are preferably made with an angle α, where α=360/(2n) and a length Lₛ=h/(cos α), where h is the thickness of the core, h=(D₁₆−D₁₄)/2. In the case when the transformer has specific long cores 16, i.e. when the length (Lₛ>D₁₆), the slant length may be determined by the formula Lₛ=D₁₆/cos α.

The coil 14 may be manufactured in a regular (circular) toroidal form, depending on the transformer production technology. The shape of the transverse section of transformer windings arranged in the coil 14 may be rectangular, circular, or any other appropriate form.

In the illustrated embodiment each toroidal core 16 consists of a first part 20 and a second part 21. The two parts 20 and 21 may be connected in a plane 22 that is perpendicular to the transformer symmetry axis.

As previously mentioned, the production technology of toroidal cores from amorphous alloy ribbon includes a toroidal core winding with its further annealing at a temperature ranging from between about 350° C. to about 550° C.

The present invention allows production technology in which each transformer element may be prepared independently with further assembling of the transformer. Thereby the technology of transformer core production from amorphous alloy ribbon may include, in accordance with the present invention, the following steps:

1. Coating an as-cast amorphous alloy ribbon with an insulating layer having a thickness of about 0.5-10 microns.

2. Winding of a toroid from the coated as-cast amorphous alloy ribbon.

3. Annealing of the ribbon at a temperature between about 350° C. and about 550° C., with or without a longitudinal or transverse magnetic field imposed.

4. Impregnation by lacquer or hermetic material at a temperature between about 15° C. and about 100° C. at normal pressure or under-pressure to provide the toroidal core with mechanical strength.

5. Cutting of the toroid along its axial plane and supplying the core with “slants” cut at their edges. To prevent the toroid layer from delamination, the cut zone is preferably clamped by a special device. The cutting may be produced by an abrasive disk with a thickness of between about 0.5 and 1 mm using water cooling. The cut surface may be polished by an abrasive wheel under water and then may be coated by electrical insulation layer with a thickness of between about 0.05 and 1 mm. This tends to prevent eddy-currents in the air gap between the transformer core parts.

The magnetic cores may then be installed on the prepared transformer polygonal or toroidal coil. After that, the transformer may be assembled in accordance with the present invention. The core air gap is preferably minimized to reduce magnetization current. For example, the gap preferably ranges between about 0.05 and 1 mm for various power transformer.

Several types of single-phase transformers, described in the “Background of the Invention”, have been compared using mathematical analysis. Transformer types identified by the numbers 1-3 in Table 2 correspond to the prior art, while transformer 4 in Table 2 corresponds to an embodiment in accordance with the present invention.

Type 1. A conventional shell-type transformer with E+1 type core made from electrical cold-rolled steel sheets with a thickness of 0.35 mm.

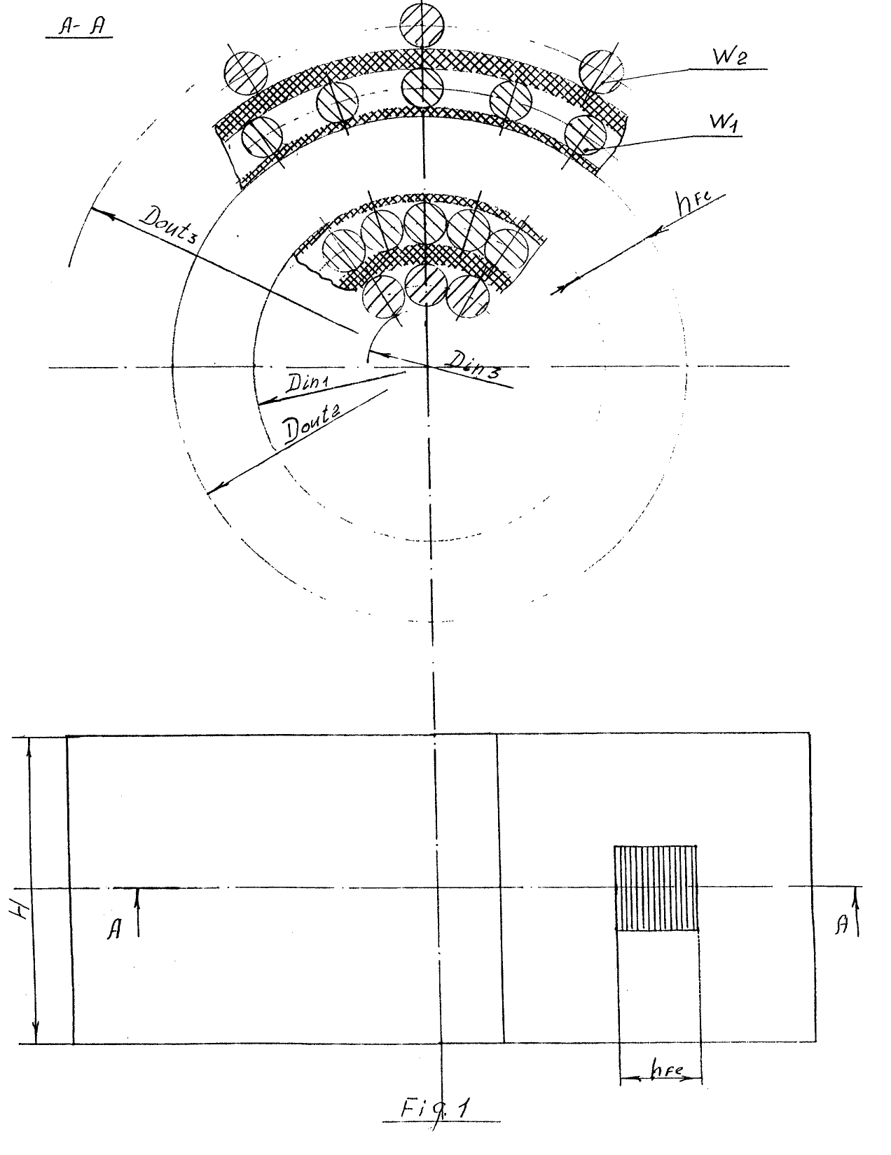

Type 2. A conventional transformer comprising two distributed windings and a toroidal core made from electrical steel strips having a thickness of between 0.1-0.15 mm, the transformer design being similar to that shown in FIG. 1.

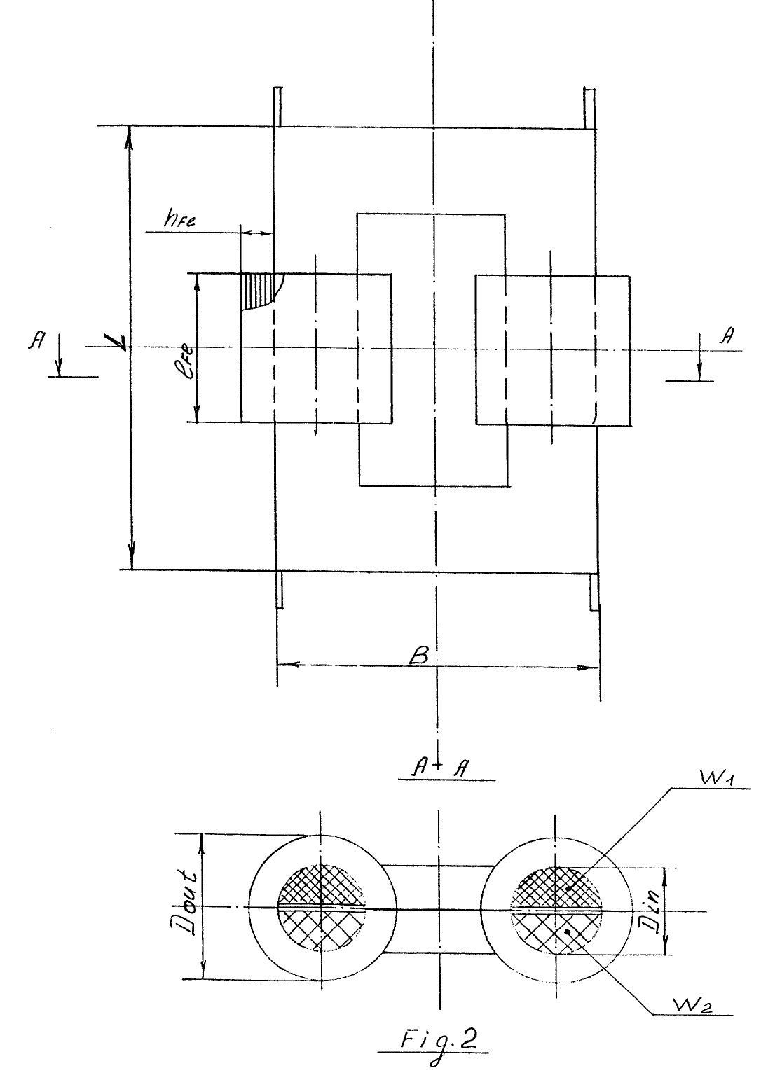

Type 3. A transformer comprising two cores wound from an electrical steel strip having a thickness of between 0.1-0.15 mm and two rectangular ring-shaped windings which extend through the core windows. The overall transformer design is similar to that shown in FIG. 2 and to the transformer which is disclosed in U.S. Pat. No. 5,387,894 and in U.S. Pat. No. 5,455,553.

Type 4. A transformer in accordance with a preferred emboidment of the present invention (as shown, for example, in FIGS. 3, 4, 5 and 6).

The mathematical analysis of these single-phase transformers was carried out using the following parameters:

Primary voltage: 380 V

Secondary voltage: 220 V

Frequency: 50 Hz

Power: 415 kW

To evaluate a new transformer design and to compare it with known transformers, a criterion must be specified. For example, it may be transformer cost or operation performance. In the present case, material consumption was used for each transformer type. The calculation was carried out as follows:

1. The turn number of the secondary winding was defined, ranging from 2 to 140.

2. The transformer electrical parameters including, in particular, the transformer efficiency, were calculated for each turn number with the given identical transformer parameters such as primary and secondary voltage, maximum current density and maximum core induction. Then, the calculation of overall transformer dimension, total weight, and core and windings weight was carried out. The total material consumption, core and coil material consumption per unit power, were then determined.

3. Characteristic values corresponding to efficiency levels of 97%, 98% and 99% are presented in Table 2:

TABLE 2

| | | Total material | Core material | Coil material |
|---|---|---|---|---|
| Trans- | | consumption | consumption | consumption |
| former | Efficiency, | per unit power, | per unit power | per unit power, |
| type | % | kg/kW | kg/kW | kg/kW |
| 1 | 97 | 1.68 | 1.29 | 0.9 |
| 2 | 97 | 1.28 | 0.82 | 0.46 |
| 3 | 97 | 1.22 | 0.81 | 0.41 |
| 4 | 97 | 0.91 | 0.5 | 0.41 |
| 1 | 97.6 | 2.575 | 2.36 | 0.215 |
| 2 | 98 | 1.71 | 1.41 | 0.3 |
| 3 | 98 | 1.7 | 1.44 | 0.26 |
| 4 | 98 | 1.00 | 0.718 | 0.282 |
| 1 | — | — | — | — |
| 2 | 99 | 7.56 | 7.42 | 0.14 |
| 3 | 99 | 3.38 | 3.22 | 0.16 |
| 4 | 99 | 2.119 | 1.985 | 0.134 |

As shown in Table 2, an efficiency level of 99% can not be achieved in variant No.1 of the transformer design.

Table 2 further demonstrates that the lowest expenditure of material is obtained in production of transformers in accordance with the present invention.

For example, if a comparison of a transformer according to the present invention is made with a conventional transformer described above as the variant No. at a 97% efficiency level, then the total mass of the transformer is decreased 1.84 times, and at a 98% efficiency, it is decreased 2.5 times.

Accordingly, at a 97% efficiency, the expenditure of core material is decreased 2.58 times, and at a 98% efficiency it is decreased 3.28 times.

The presently disclosed embodiments are to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A transformer, comprising:
two distributed windings, and
a toroidal core comprising at least one of an amorphous alloy ribbon and a nanocrystalline ribbon.

2. A transformer, comprising:
a substantially polygonal coil having n sides and defining a central window, the coil comprising at least a first winding and a second winding,
a plurality of cores disposed substantially adjacent to and along the transformer coil perimeter and extending through the central window, at least one of the plurality of cores comprising at least one of an amorphous ribbon or a nanocrystalline ribbon.

3. The transformer of claim 2 wherein the coil defines a substantially circular cross section.

4. The transformer of claim 2 wherein the coil defines a substantially rectangular cross section.

5. The transformer of claim 2 wherein at least one of the first winding and the second winding comprises a plurality of wires arranged substantially parallel to at least one of the n sides of the polygonal coil.

6. The transformer of claim 2 wherein the coil has a substantially toroidal shape and defines a substantially circular cross section.

7. The transformer of claim 6 wherein the coil defines a substantially rectangular cross section.

8. The transformer of claim 2 wherein at least one of the plurality of cores defines an axial plane having a rectangular cross section.

9. The transformer of claim 2 wherein the core is wound from a strip.

10. The transformer of claim 2 wherein the coil defines an axis, wherein the transformer defines a symmetry axis, and wherein at least one of the cores extending through the central window defines a substantially planar slant edge located substantially coincident with a plane intersecting the transformer symmetry axis, thereby increasing total effective core section area in a plane substantially perpendicular to the coil axis.

11. The transformer of claim 10 wherein the substantially planar slant edge defines an angle α and a length Ls, and wherein the angle α of the slant edge is equal to 360/2n and the length Ls of the slant edge is equal to h/cos α.

12. The transformer of claim 2 wherein the transformer defines a central axis, wherein at least one of the cores defines a first section having a plane and a second section having a plane, and wherein the plane of the first section and the plane of the second section are substantially adjacent and substantially perpendicular to the transformer central axis.

13. An electrical transformer, comprising:
a substantially polygonal-shaped coil comprising at least a first winding and a second winding and defining a central window, and
a plurality of magnetic cores located along the coil and extending through the central window, wherein at least one of the cores comprises at least one of an as cast amorphous and nanocrystalline ribbon annealed at an annealing temperature ranging from about 350° C. to about 550° C.

14. The transformer of claim 13, wherein the transformer defines a symmetry axis and wherein a portion of at least one of the cores extending through the central window defines a slant surface that lies in a plane which intersects the transformer symmetry axis.

15. The transformer of claim 14, wherein the coil defines a polygon having n sides, wherein at least one of the cores has a thickness h, and wherein the slant surface defines an angle a and a length L, where α=360/(2n) and L=h/(cos α).

16. The transformer of claim 14, wherein at least one of the cores defines an inner diameter D, and wherein the slant surface defines a length L, where L>D and L=D/cos α.

17. The transformer of claim 13, wherein the transformer defines a symmetry axis and wherein at least one of the cores comprises a first part and a second part, the first part and the second part being connectable along a plane that is substantially perpendicular to the transformer symmetry axis.

18. A method of making an electrical transformer, comprising:
providing at least one of an as cast amorphous ribbon and a nanocrystalline ribbon,
winding a toroid from the ribbon, the toroid defining an axial plane,
annealing the toroid at a temperature between about 350° C. and about 550° C.,
dividing the toroid along its axial plane,
providing the toroid with at least one slant surface,
providing at least one of a polygonal coil and a toroidal coil, and
placing the toroid around the coil.

19. The method of claim 18, comprising:
coating the ribbon with an insulating layer having a thickness of between about 0.5 microns and about 10 microns.

20. The method of claim 18, wherein the step of annealing the toroid further comprises the step of imposing at least one of a longitudinal magnetic field and a transverse magnetic field.

21. The method of claim 18, comprising:
impregnating the toroid with at least one of lacquer and hermetic material at a temperature between about 15° C. and about 100° C.
